(19) United States
(12) Patent Application Publication
(10) Pub. No.: US 2024/0056939 A1
(43) Pub. Date: Feb. 15, 2024

(54) RELAYING INFORMATION USING ONE OR MORE RELAYS

(71) Applicant: LENOVO (BEIJING) LIMITED, Beijing (CN)

(72) Inventors: Prateek Basu Mallick, Dreieich (DE); Joachim Löhr, Wiesbaden (DE); Lianhai Wu, Beijing (CN); Karthikeyan Ganesan, Nauheim (DE)

(21) Appl. No.: 18/260,116

(22) PCT Filed: Dec. 31, 2020
(86) PCT No.: PCT/CN2020/142216

§ 371 Date: Jun. 30, 2023

(51) Int. Cl. H04W 40/22

(52) U.S. Cl. CPC H04W 40/22

(57) ABSTRACT

Apparatuses, methods, and systems are disclosed for relaying information using one or more relays. One method (800) includes selecting (802) at least one relay for data information transmission, control information transmission, or a combination thereof. The method (800) includes determining (804) whether the at least one relay comprises a plurality of relays. The method (800) includes, in response to determining that the at least one relay comprises a plurality of relays, transmitting (806) information to a relay device indicating that the at least one relay comprises the plurality of relays.

### FIELD

The subject matter disclosed herein relates generally to wireless communications and more particularly relates to relaying information using one or more relays.

### BACKGROUND

The following abbreviations are herewith defined, at least some of which are referred to within the following description: First Stage SCI (“1 st SCI”), Second Stage SCI (“2 nd SCI”), Third Generation Partnership Project (“3GPP”), 5G Globally Unique Temporary UE Identifier (“5G-GUTI”), 5G QoS Indicator (“5QI”), Authentication Authorization and Accounting (“AAA”), Acknowledge Mode (“AM”), Access and Mobility Management Function (“AMF”), Aperiodic (“AP”), Authentication Server Function (“AUSF”), Backhaul (“BH”), Broadcast Multicast (“BM”), Buffer Occupancy (“BO”), Base Station (“BS”), Buffer Status Report (“BSR”), Bandwidth (“BW”), Bandwidth Part (“BWP”), Carrier Aggregation (“CA”), Code Block Group (“CBG”), CBG Flushing Out Information (“CBGFI”), CBG Transmission Information (“CBGTI”), Channel Busy Ratio (“CBR”), Component Carrier (“CC”), Control Channel Element (“CCE”), Code Division Multiplexing (“CDM”), Control Element (“CE”), Coordinated Multipoint (“CoMP”), Categories of Requirements (“CoR”), Control Resource Set (“CORESET”), Cyclic Prefix (“CP”), Cyclic Prefix OFDM (“CP-OFDM”), Channel Occupancy Ratio (“CR”), Cyclic Redundancy Check (“CRC”), CSI-RS Resource Indicator (“CRI”), Cell RNTI (“C-RNTI”), Channel State Information (“CSI”), CSI IM (“CSI-IM”), CSI RS (“CSI-RS”), Channel Quality Indicator (“CQI”), Central Unit (“CU”), Codeword (“CW”), Downlink Assignment Index (“DAI”), Downlink Control Information (“DCI”), Downlink Feedback Information (“DFI”), Downlink (“DL”), Discrete Fourier Transform Spread OFDM (“DFT-s-fOFDM”), Demodulation Reference Signal (“DMRS” or “DM-RS”), Data Radio Bearer (“DRB”), Dedicated Short-Range Communications (“DSRC”), Discontinuous Reception (“DRX”), Distributed Unit (“DU”), Enhanced Mobile Broadband (“eMBB”), Evolved Node B (“eNB”), Enhanced Subscriber Identification Module (“eSIM”), Enhanced (“E”), Edge Application Server (“EAS”), Edge Configuration Server (“ECS”), Edge Enabler Client (“EEC”), Edge Enabler Server (“EES”), Frequency Division Duplex (“FDD”), Frequency Division Multiplexing (“FDM”), Frequency Division Multiple Access (“FDMA”), Fully-Qualified Domain Name (“FQDN”), Frequency Range (“FR”), 450 MHz-6000 MHz (“FR1”), 24250 MHz-52600 MHz (“FR2”), RAN Network Node (“gNB”), Globally Unique Temporary UE Identifier (“GUTI”), Hybrid Automatic Repeat Request (“HARQ”), High-Definition Multimedia Interface (“HDMI”), High-Speed Train (“HST”), Integrated Access Backhaul (“IAB”), Identity or Identifier or Identification (“ID”), Information Element (“IE”), Interference Measurement (“IM”), International Mobile Subscriber Identity (“IMSI”), Internet-of-Things (“IoT”), Internet Protocol (“IP”), Joint Transmission (“JT”), Key Derivation Function (“KDF”), Level 1 (“L1”), L1 RSRP (“L1-RSRP”), L1 SINR (“L1-SINR”), Logical Channel (“LCH”), Logical Channel Group (“LCG”), Logical Channel ID (“LCID”), Logical Channel Prioritization Procedure (“LCP”), Layer Indicator (“LI”), Least-Significant Bit (“LSB”), Long Term Evolution (“LTE”), Levels of Automation (“LoA”), Medium Access Control (“MAC”), Message Authentication Code for Integrity (“MAC-I”), Modulation Coding Scheme (“MCS”), Multi DCI (“M-DCI”), Mobile Edge Computing (“MEC”), Master Information Block (“MIB”), Multiple Input Multiple Output (“MIMO”), Maximum Permissible Exposure (“MPE”), Most-Significant Bit (“MSB”), Mobile Station International Subscriber Directory Number (“MSISDN”), Mobile-Termination (“MT”), Machine Type Communication (“MTC”), Multi PDSCH (“Multi-PDSCH”), Multi TRP (“M-TRP”), Multi-User (“MU”), Multi-User MIMO (“MU-MIMO”), Minimum Mean Square Error (“MMSE”), Negative-Acknowledgment (“NACK”) or (“NAK”), Network Access Identifier (“NAI”), Non Access Stratum (“NAS”), Non-Coherent Joint Transmission (“NCJT”), Network Exposure Function (“NEF”), Next Generation (“NG”), Next Generation Node B (“gNB”), Generic Public Subscription Identifier (“GPSI”), New Radio (“NR”), Non-Zero Power (“NZP”), NZP CSI-RS (“NZP-CSI-RS”), Orthogonal Frequency Division Multiplexing (“OFDM”), Peak-to-Average Power Ratio (“PAPR”), Physical Broadcast Channel (“PBCH”), Physical Downlink Control Channel (“PDCCH”), Physical Downlink Shared Channel (“PDSCH”), PDSCH Configuration (“PDSCH-Config”), Air Interface Between Two UEs Used Such As For Vehicular Communications (“PC5”), Policy Control Function (“PCF”), Packet Delay Budget (“PDB”) (latency of a packet), Packet Data Convergence Protocol (“PDCP”), Packet Data Network (“PDN”), Protocol Data Unit (“PDU”), Permanent Equipment Identifier (“PEI”), Physical Layer (“PHY”), Public Land Mobile Network (“PLMN”), Precoding Matrix Indicator (“PMI”), ProSe Per Packet Priority (“PPPP”), ProSe Per Packet Reliability (“PPPR”), Physical Resource Block (“PRB”), Packet Switched (“PS”), Physical Sidelink Control Channel (“PSCCH”), Physical Sidelink Feedback Channel (“PSFCH”), Physical Sidelink Shared Channel (“PSSCH”), Phase Tracking RS (“PTRS” or “PT-RS”), Physical Uplink Control Channel (“PUCCH”), Physical Uplink Shared Channel (“PUSCH”), Quasi Co-Located (“QCL”), Quality of Service (“QoS”), Random Access Channel (“RACH”), Radio Access Network (“RAN”), Radio Access Technology (“RAT”), Resource Element (“RE”), Radio Frequency (“RF”), Rank Indicator (“RI”), Radio Link Control (“RLC”), Radio Link Failure (“RLF”), Radio Network Temporary Identifier (“RNTI”), Resource Pool (“RP”), Radio Resource Control (“RRC”), Remote Radio Head (“RRH”), Reference Signal (“RS”), Reference Signal Received Power (“RSRP”), Reference Signal Received Quality (“RSRQ”), Received Signal Strength Indicator (“RSSI”), Redundancy Version (“RV”), Receive (“RX”), Security Association (“SA”), Service Based Architecture (“SBA”), Single Carrier Frequency Domain Spread Spectrum (“SC-FDSS”), Secondary Cell (“SCell”), Sidelink Control Information (“SCI”), Spatial Channel Model (“SCM”), Sub Carrier Spacing (“SCS”), Single DCI (“S-DCI”), Spatial Division Multiplexing (“SDM”), Service Data Unit (“SDU”), Single Frequency Network (“SFN”), Subscriber Identity Module (“SIM”), Signal-to-Interference Ratio (“SINR”), Sidelink (“SL”), Sidelink Discontinuous Reception (“SL DRX”), Session Management Function (“SMF”), Sequence Number (“SN”), Semi Persistent (“SP”), Scheduling Request (“SR”), SRS Resource Indicator (“SRI”), Sounding Reference Signal (“SRS”), Synchronization Signal (“SS”), SS/PBCH Block (“SSB”), Subscription Concealed Identifier (“SUCI”), Subscription Permanent Identifier (“SUPI”), Transport Block (“TB”), Transmission Configuration Indication (“TCI”), Time Division Duplex (“TDD”), Time Division Multiplexing (“TDM”), Temporary Mobile Subscriber Identity (“TMSI”), Transmit Power Control (“TPC”), Transmitted Precoding Matrix Indicator (“TPMI”), Transmission Reception Point (“TRP”), Transmission Reference Signal (“TRS”), Technical Standard (“TS”), Transmit (“TX”), Transmitter UE (“TX UE”), Unified Data Management (“UDM”), User Data Repository (“UDR”), User Entity/Equipment (Mobile Terminal) (“UE”), Universal Integrated Circuit Card (“UICC”), Uplink (“UL”), Unacknowledged Mode (“UM”), Universal Mobile Telecommunications System (“UMTS”), LTE Radio Interface (“Uu interface”), User Plane (“UP”), User Plane Function (“UPF”), Ultra Reliable Low Latency Communication (“URLLC”), Universal Subscriber Identity Module (“USIM”), Universal Terrestrial Radio Access Network (“UTRAN”), Air Interface Between UE and gNB (“Uu”), Vehicle to Everything (“V2X”), Voice Over IP (“VoIP”), Visited Public Land Mobile Network (“VPLMN”), Virtual Resource Block (“VRB”), Vehicle RNTI (“V-RNTI”), Worldwide Interoperability for Microwave Access (“WiMAX”), Zero Forcing (“ZF”), Zero Power (“ZP”), and ZP CSI-RS (“ZP-CSI-RS”). As used herein, “HARQ-ACK” may represent collectively the Positive Acknowledge (“ACK”) and the Negative Acknowledge (“NAK”). ACK means that a TB is correctly received while NAK means a TB is erroneously received.

In certain wireless communications networks, relays may be used.

### BRIEF SUMMARY

Methods for relaying information using one or more relays are disclosed. Apparatuses and systems also perform the functions of the methods. In one embodiment, the method includes selecting at least one relay for data information transmission, control information transmission, or a combination thereof. In certain embodiments, the method includes determining whether the at least one relay comprises a plurality of relays. In various embodiments, the method includes, in response to determining that the at least one relay comprises a plurality of relays, transmitting information to a relay device indicating that the at least one relay comprises the plurality of relays.

An apparatus for relaying information using one or more relays, in one embodiment, includes a processor that: selects at least one relay for data information transmission, control information transmission, or a combination thereof; determines whether the at least one relay comprises a plurality of relays; and, in response to determining that the at least one relay comprises a plurality of relays, transmits information to a relay device indicating that the at least one relay comprises the plurality of relays.

In various embodiments, a method for relaying information using one or more relays includes receiving data from a first interface. In some embodiments, the method includes transmitting the data from the first interface to a second interface. In certain embodiments, the method includes maintaining a packet data convergence protocol sequence number in the data from the first interface when transmitting the data from the first interface to the second interface.

An apparatus for relaying information using one or more relays, in some embodiments, includes a processor that: receives data from a first interface; transmits the data from the first interface to a second interface; and maintains a packet data convergence protocol sequence number in the data from the first interface when transmitting the data from the first interface to the second interface.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for relaying information using one or more relays;

FIG. 2 is a schematic block diagram illustrating one embodiment of an apparatus that may be used for relaying information using one or more relays;

FIG. 3 is a schematic block diagram illustrating another embodiment of an apparatus that may be used for relaying information using one or more relays;

FIG. 4 is a communications diagram illustrating one embodiment of communications for relaying information using one or more relays;

FIG. 5 is a communications diagram illustrating one embodiment of a L3 relay UE;

FIG. 6 is a communications diagram illustrating one embodiment of UE to network communications;

FIG. 7 is a communications diagram illustrating one embodiment of UE to UE communications;

FIG. 8 is a schematic flow chart diagram illustrating one embodiment of a method for relaying information using one or more relays; and

FIG. 9 is a schematic flow chart diagram illustrating another embodiment of a method for relaying information using one or more relays.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures Like numbers refer to like elements in all figures, including alternate embodiments of like elements.

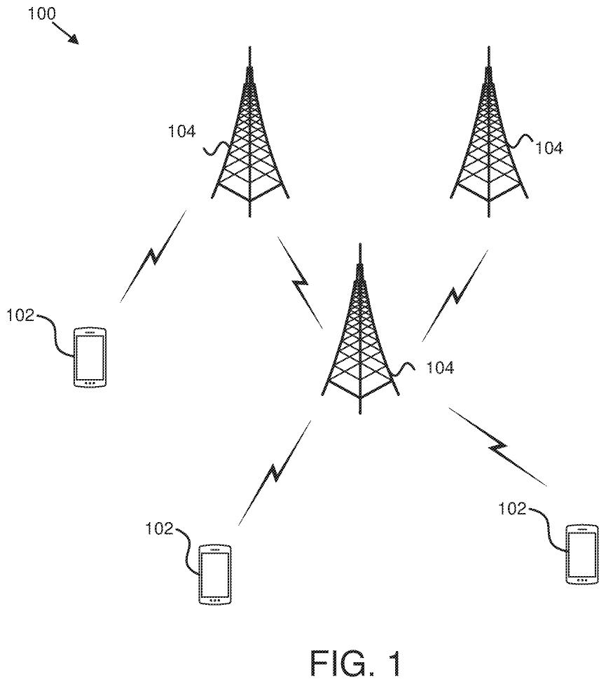

FIG. 1 depicts an embodiment of a wireless communication system 100 for relaying information using one or more relays. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a RAN, a relay node, a device, a network device, an IAB node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the 3GPP protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may select at least one relay for data information transmission, control information transmission, or a combination thereof. In certain embodiments, the remote unit 102 and/or the network unit 104 may determine whether the at least one relay comprises a plurality of relays. In various embodiments, the remote unit 102 and/or the network unit 104 may, in response to determining that the at least one relay comprises a plurality of relays, transmit information to a relay device indicating that the at least one relay comprises the plurality of relays. Accordingly, a remote unit 102 and/or a network unit 104 may be used for relaying information using one or more relays.

In some embodiments, a remote unit 102 and/or a network unit 104 may receive data from a first interface. In some embodiments, the remote unit 102 and/or the network unit 104 may transmit the data from the first interface to a second interface. In certain embodiments, the remote unit 102 and/or the network unit 104 may maintain a packet data convergence protocol sequence number in the data from the first interface when transmitting the data from the first interface to the second interface. Accordingly, a remote unit 102 and/or a network unit 104 may be used for relaying information using one or more relays.

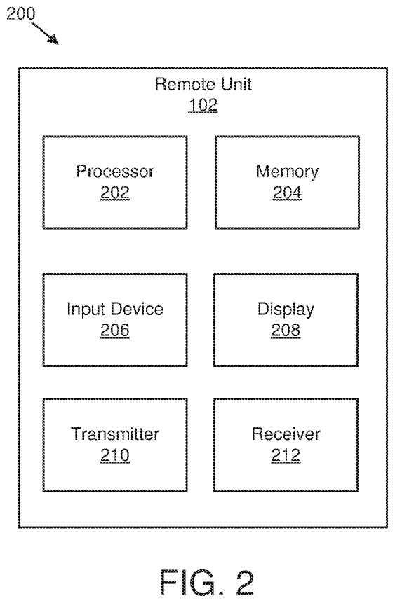

FIG. 2 depicts one embodiment of an apparatus 200 that may be used for relaying information using one or more relays. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In one embodiment, the processor 202 may: select at least one relay for data information transmission, control information transmission, or a combination thereof; determine whether the at least one relay comprises a plurality of relays; and, in response to determining that the at least one relay comprises a plurality of relays, transmit information to a relay device indicating that the at least one relay comprises the plurality of relays.

In various embodiments, the processor 202 may: receive data from a first interface; transmit the data from the first interface to a second interface; and maintain a packet data convergence protocol sequence number in the data from the first interface when transmitting the data from the first interface to the second interface.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

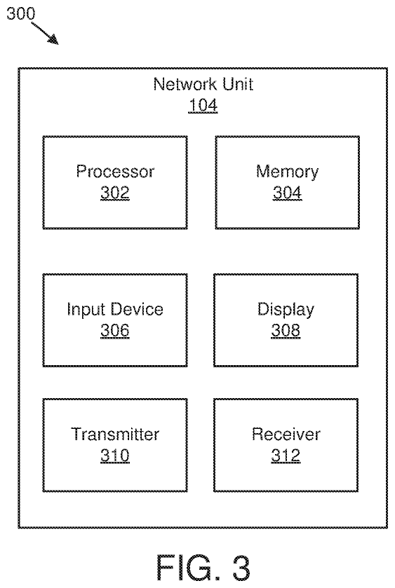

FIG. 3 depicts another embodiment of an apparatus 300 that may be used for relaying information using one or more relays. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In one embodiment, the processor 302 may: select at least one relay for data information transmission, control information transmission, or a combination thereof; determine whether the at least one relay comprises a plurality of relays; and, in response to determining that the at least one relay comprises a plurality of relays, transmit information to a relay device indicating that the at least one relay comprises the plurality of relays.

In various embodiments, the processor 302 may: receive data from a first interface; transmit the data from the first interface to a second interface; and maintain a packet data convergence protocol sequence number in the data from the first interface when transmitting the data from the first interface to the second interface.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In various embodiments, two types of relays may be used: 1) a UE-to-network coverage extension in which Uu coverage reachability is necessary for UEs to reach a server in a PDN network or a counterpart UE out of a proximity area—in some embodiments a UE-to-network relay is limited to EUTRA-based technology and may not be applied to NR-based system (e.g., for both NG-RAN and NR-based sidelink communication); and 2) UE-to-UE coverage extension in which proximity reachability is limited to single-hop sidelink link, either via EUTRA-based or NR-based sidelink technology.

In various embodiments, reliability requirements are changing. For example, a required reliability may be as high as 10\hat{ }-6 for mission critical delay sensitive signaling (e.g., MC-PTT signaling) and/or mission critical data. As another example, for communication service availability (“CSA”), a required reliability may be increased.

It should be noted that, as used herein, a UE-to-network relay may be referred to as an N-relay or U2N. Furthermore, as used herein a UE-to-UE relay may be referred to as a UE-relay or U2U. Moreover, as used herein a relay may be either a U2N and/or U2U relay.

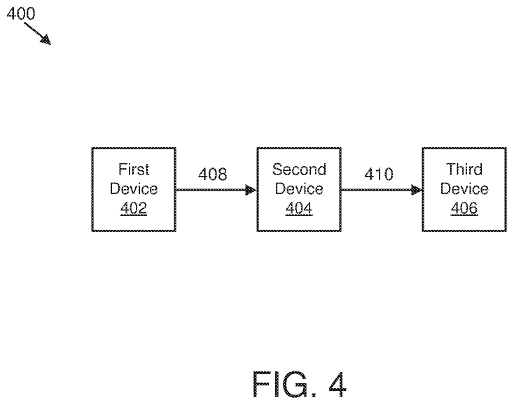

FIG. 4 is a communications diagram 400 illustrating one embodiment of communications for relaying information using one or more relays. The communications diagram 400 illustrates communications between a first device 402 (e.g., TX-Remote-UE, UE1), a second device 404 (e.g., relay, UE2), and a third device 406 (e.g., TX-Remote-UE, UE3, gNB). Communications between the first device 402 and the second device 404 may be via a first interface 408 (e.g., interface 1), and communications between the second device 404 and the third device 406 may be via a second interface 410 (e.g., interface 2).

The first device 402 may be a UE that has some application data to be sent to the third device 406 (e.g., another remote UE or the gNB) in UL direction as shown in FIG. 4, via the second device 404. As may be appreciated, the third device 406 may have data to send to the first device 402 via the second device 404 (e.g., the third device 406 would function as a transmitter instead of a receiver). Accordingly, as may be appreciated, the terms and roles described in relation to FIG. 4 may be with respect to a particular data packet only. In various embodiments, more than one relay may be used (e.g., one or more second devices 404). In certain embodiments, the third device 406 may act as a relay UE to another device (e.g., another UE and/or a gNB).

It should be noted that embodiments described herein may involve communications transmitted from the first device 402 to one or more second devices 404 then to the third device 406 and/or communications transmitted from the third device 406 to one or more second devices 404 then to the first device 402.

In a first embodiment, when using an L3 architecture for U2N or U2U relays, PDCP protocol at the first device 402 duplicates PDCP SDUs into more than one replica. Each of these duplicated packets may travel to a different relay node. The PDCP layer of these relays may process the received PDCP PDUs and forward them to an upper layer. In such embodiments, a sequence number (“SN”) of a received PDCP PDU from the first device 402 may be maintained while delivering (e.g., transmitting) the PDCP PDU on the second interface 410 (e.g., Uu if the second device 404 is a U2N relay and PC5 if the second device 404 is a U2U relay). Thus, a receiver PDCP of the third device 406 may facilitate removing duplicates.

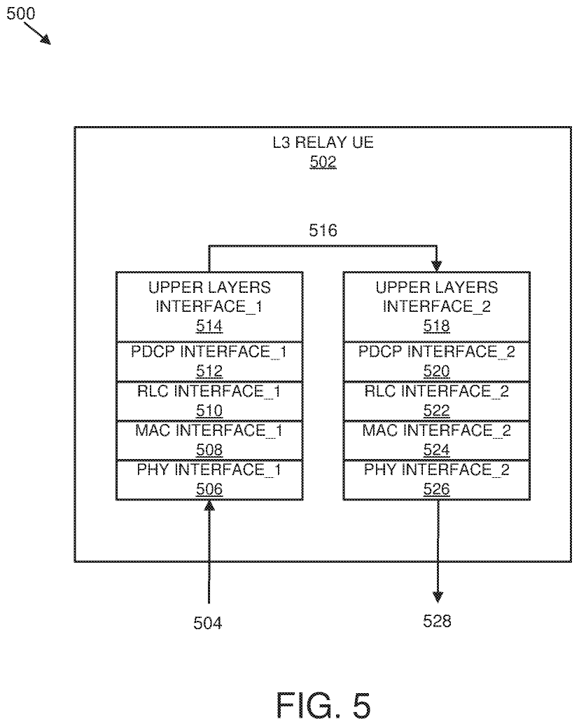

FIG. 5 is a communications diagram 500 illustrating one embodiment of a L3 relay UE 502. The L3 relay UE 502 receives a message 504 from a first device (e.g., the first device 402) on a first interface (e.g., the first interface 408). The L3 relay UE 502 breaks down the message 504 via a PHY interface_1 506, MAC interface_1 508, RLC interface_1 510, and PDCP interface_1 512 which provides the broken down message 504 to upper layers interface_1 514. The upper layers interface_1 514 provides the message 504 to upper layers interface_2 518 for the message 504 to be repackaged in a second interface. The upper layers interface_2 518 provides the message 504 to PDCP interface_2 520, RLC interface_2 522, MAC interface_2 524, and PHY interface_2 526 which provides a repackaged message 528 to a third device (e.g., the third device 406) on a second interface (e.g., the second interface 410).

In a first implementation of the first embodiment, a receiving PDCP entity (e.g., PDCP protocol on Interface-1 of the L3 relay UE 502, PDCP interface_1 514) does not remove a PDCP header before forwarding a SDU from the message 504 to the upper layers interface_1 514. The upper layers interface_1 514 may include SDAP, IP, PDU, and/or other layers. The upper layers interface_1 514 is made aware of this (e.g., not removing the PDCP header) and told how many octets are in the PDCP header. The upper layers interface_1 514 starts processing as usual but starts processing with a next octet after octets containing the indicated PDCP header. The upper layers interface_1 514 provides the processed PDU to the upper layers interface_2 518 but keeps the PDCP header intact. The PDCP interface_2 520, upon receiving the SDU from the upper layers interface_2 518, processes the SDU as usual as described for that RAT except that instead of assigning a PDCP SN, the same SN as received in the SDU is used. All the remaining header information is ignored and the PDCP interface_2 520 builds the header from scratch except for the PDCP SN as described for that RAT. Thus, the SN is maintained from the first interface to the second interface.

In a second implementation of the first embodiment, all is done as described in the first implementation of the first embodiment except that all non PDCP SN bits are reset by the PDCP interface_1 512 when forwarding the data to the upper layers interface_1 514.

In a third implementation of the first embodiment, the PDCP interface_1 512 removes the entire header when forwarding the data to the upper layers interface_1 514. The received PDCP SN is carried separately per PDCP SDU to the upper layers interface_1 514. The SN information is maintained throughout the processing and delivered to the PDCP interface_2 520 along with the corresponding SDU. The PDCP interface_2 520, upon receiving the SDU from the upper layers interface_2 518, processes the SDU as usual as described for that RAT except that instead of assigning a PDCP SN, the same SN as received along with the SDU is used.

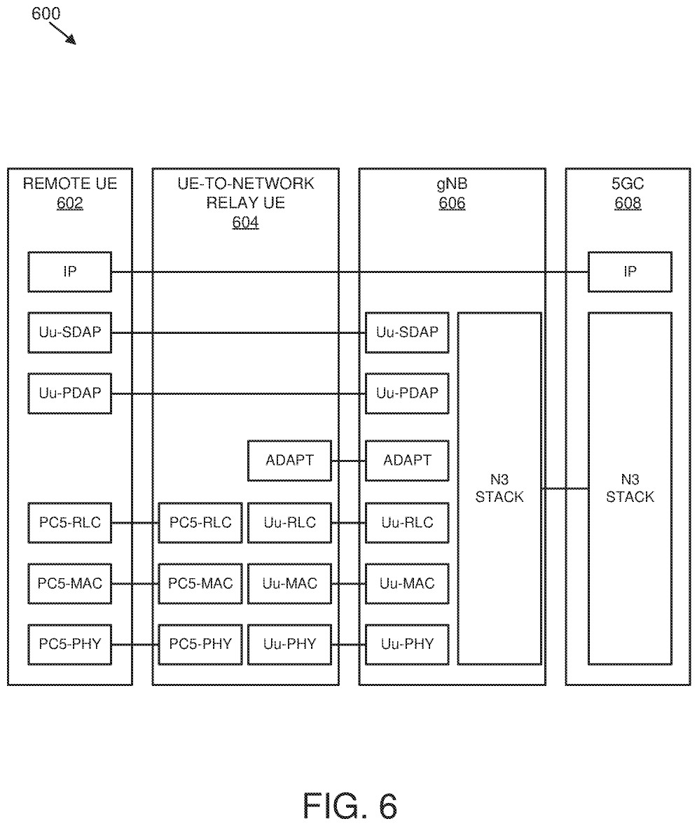

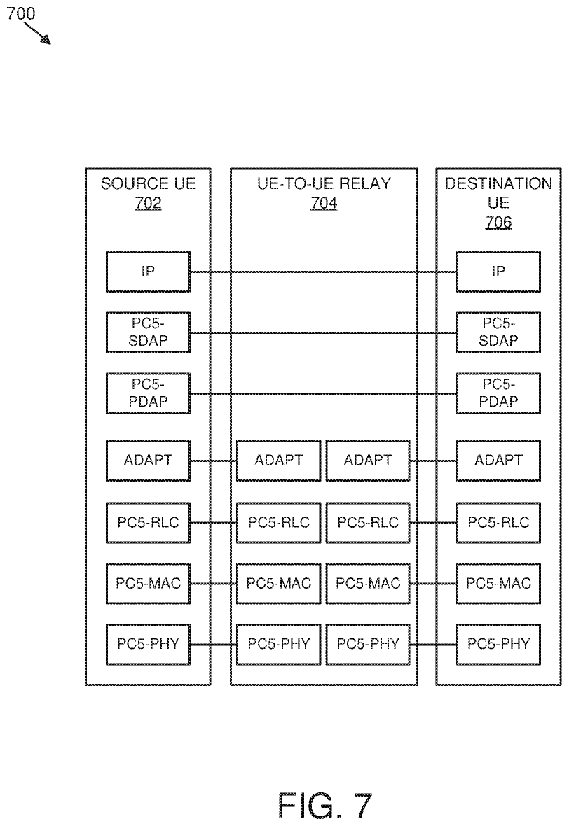

A second embodiment may be applicable to L3 relay architectures and/or to any L2 architecture (e.g., such as the architectures illustrated in FIGS. 6 and 7).

FIG. 6 is a communications diagram 600 illustrating one embodiment of UE to network communications between a remote UE 602, a UE-to-network relay UE 604, a gNB 606 and a 5GC 608. As may be appreciated, the PC5-RLC, PC5-MAC, and PC5 PHY communications may occur via a RLC channel, the ADAPT, Uu-RLC, Uu-MAC, and Uu-PHY communications may occur via a Uu DRB, and the N3 stack communications may occur via a GTP-U tunnel.

FIG. 7 is a communications diagram 700 illustrating one embodiment of UE to UE communications between a source UE 702, a UE-to-UE relay 704, and a destination UE 706. As may be appreciated, the ADAPT, PC5-RLC, PC5-MAC, and PC5 PHY communications may occur via RLC channels.

In the second embodiment, a network may control whether multiple paths are used using a configuration and/or preconfiguration. In one implementation of the second embodiment, the network control may be semi-static on a per bearer basis and/or configured while configuring the bearer. One use of this implementation may be for Mode 1 bearers.

In another implementation of the second embodiment, the network control may be on a radio basis. A remote-TX UE may determine whether a radio (e.g., on two interfaces) using any selected relays serving a destination is insufficient or inefficient to fulfill a required QoS (“PQI”). One way to achieve this is by a gNB configures and/or preconfiguring certain thresholds for each of the two interfaces.

For example, for an ith relay (e.g., i=1 to number of candidate and/or selected relays), Qinterface-1>Threshold-highinterface-1 AND Qinterface-2>Threshold-highinterface-2, select ith relay and therefore do not use any other mechanism (e.g., like PDCP duplication) to increase reliability; else, select the first ‘n’ best relays each fulfilling the following conditions: for an ith relay: Qinterface-1>Threshold-lowinterface-1 AND Qinterface-2>Threshold-lowinterface-2.

In the above example, the fours thresholds (Threshold-highinterface-1, Threshold-lowinterface-1 and Threshold-highinterface-2, Threshold-lowinterface-2) are configured and/or preconfigured. This implementation may be for Mode 2 bearers. Using one of the two implementations of the second embodiment, a UE may determine if relaying using more than one relay needs to be used.

In a third embodiment, the first and second embodiments may be combined in an L3 relaying case: the relay UE “maintains” the received PDCP SN from the interface-1 on the interface-2 only if a first device is relaying using more than one relays. To this end, the first device sends an indication indicating “relaying using more than one relays” using one of the following implementations: In a first implementation, the indication may be provided at PDCP layer using one of the reserved bit ‘R’ if available. As an alternative or when no ‘R’ bit is available (e.g., Data PDU for sidelink DRBs for unicast with 12 bits PDCP SN case), a new octet is used in a PDCP header with the first bit indicating if “relaying using more than one relays” and remaining 7 bits are kept for future use as ‘R’ bits. In a second implementation, the indication is provided in a lower layer (e.g., SCI). In a third implementation, upper layers in a UE may signal if multiple relays are being used to the relay UE using, for example, PC5 RRC or MAC signaling for a given PC5 bearer.

In some embodiments described herein, a PDCP SN number may be maintained between two different interfaces when an L3 relay node is used. In various embodiments, a network may control and/or configure use of multiple relays to provide diversity and/or reliability. In some embodiments, there may be different means of providing an indication by a transmitting device (e.g., remote UE or gNB) to a relay UE indicating if relaying is done using multiple relays. The relay UE may maintain a PDCP SN number between two different interfaces only if the transmitting device is relaying using multiple relays.

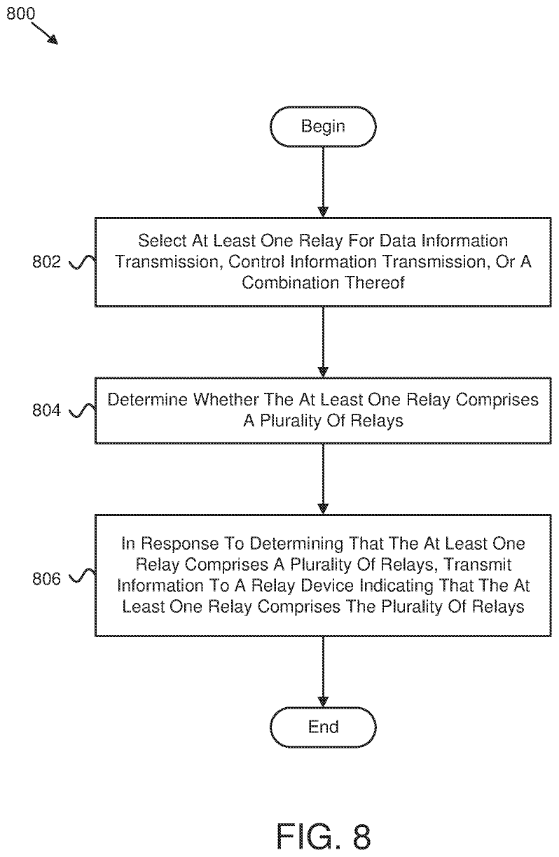

FIG. 8 is a schematic flow chart diagram illustrating one embodiment of a method 800 for relaying information using one or more relays. In some embodiments, the method 800 is performed by an apparatus, such as the remote unit 102 and/or the network unit 104. In certain embodiments, the method 800 may be performed by a processor executing program code, for example, a microcontroller, a microprocessor, a CPU, a GPU, an auxiliary processing unit, a FPGA, or the like.

The method 800 may include selecting 802 at least one relay for data information transmission, control information transmission, or a combination thereof. In certain embodiments, the method 800 includes determining 804 whether the at least one relay comprises a plurality of relays. In various embodiments, the method 800 includes, in response to determining that the at least one relay comprises a plurality of relays, transmitting 806 information to a relay device indicating that the at least one relay comprises the plurality of relays.

In certain embodiments, the device comprises a user equipment or a network device. In some embodiments, determining whether the at least one relay comprises the plurality of relays comprises determining whether the at least one relay comprises the plurality of relays based on a logical channel configuration.

In various embodiments, determining whether the at least one relay comprises the plurality of relays comprises determining whether the at least one relay comprises the plurality of relays based on radio thresholds configured by a network. In one embodiment, determining whether the at least one relay comprises the plurality of relays comprises determining whether the at least one relay comprises the plurality of relays based on radio thresholds preconfigured by a network.

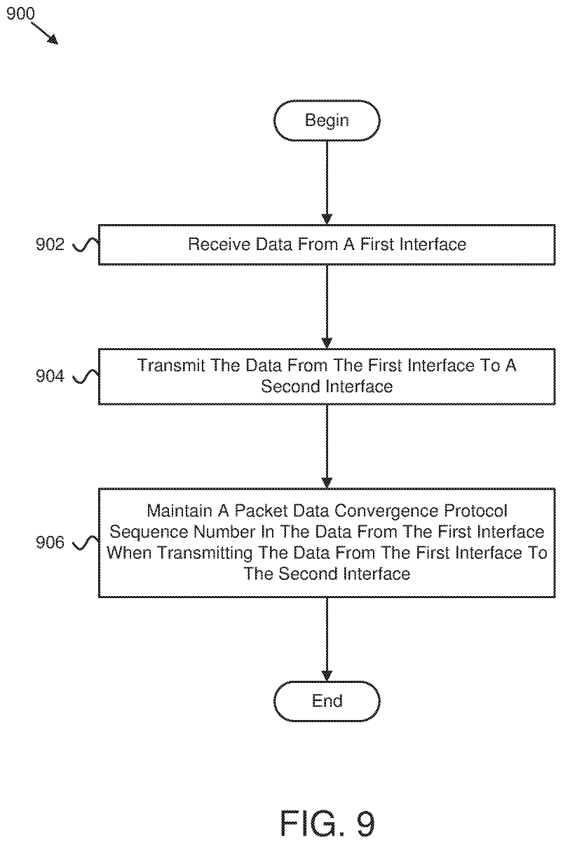

FIG. 9 is a schematic flow chart diagram illustrating another embodiment of a method 900 for relaying information using one or more relays. In some embodiments, the method 900 is performed by an apparatus, such as the remote unit 102 and/or the network unit 104. In certain embodiments, the method 900 may be performed by a processor executing program code, for example, a microcontroller, a microprocessor, a CPU, a GPU, an auxiliary processing unit, a FPGA, or the like.

The method 900 may include receiving 902 data from a first interface. In some embodiments, the method 900 includes transmitting 904 the data from the first interface to a second interface. In certain embodiments, the method 900 includes maintaining 906 a packet data convergence protocol sequence number in the data from the first interface when transmitting the data from the first interface to the second interface.

In certain embodiments, maintaining the packet data convergence protocol sequence number in the data from the first interface when transmitting the data from the first interface to the second interface comprises maintaining the packet data convergence protocol sequence number in the data from the first interface when transmitting the data from the first interface to the second interface in response to relaying with a plurality of relays.

In one embodiment, a method is performed by a device. In such an embodiment, the method comprises: selecting at least one relay for data information transmission, control information transmission, or a combination thereof; determining whether the at least one relay comprises a plurality of relays; and, in response to determining that the at least one relay comprises a plurality of relays, transmitting information to a relay device indicating that the at least one relay comprises the plurality of relays.

In certain embodiments, the device comprises a user equipment or a network device.

In some embodiments, determining whether the at least one relay comprises the plurality of relays comprises determining whether the at least one relay comprises the plurality of relays based on a logical channel configuration.

In various embodiments, determining whether the at least one relay comprises the plurality of relays comprises determining whether the at least one relay comprises the plurality of relays based on radio thresholds configured by a network.

In one embodiment, determining whether the at least one relay comprises the plurality of relays comprises determining whether the at least one relay comprises the plurality of relays based on radio thresholds preconfigured by a network.

In one embodiment, an apparatus comprising a device. In such an embodiment, the apparatus further comprises: a processor that: selects at least one relay for data information transmission, control information transmission, or a combination thereof; determines whether the at least one relay comprises a plurality of relays; and, in response to determining that the at least one relay comprises a plurality of relays, transmits information to a relay device indicating that the at least one relay comprises the plurality of relays.

In certain embodiments, the device comprises a user equipment or a network device.

In some embodiments, the processor determining whether the at least one relay comprises the plurality of relays comprises the processor determining whether the at least one relay comprises the plurality of relays based on a logical channel configuration.

In various embodiments, the processor determining whether the at least one relay comprises the plurality of relays comprises the processor determining whether the at least one relay comprises the plurality of relays based on radio thresholds configured by a network.

In one embodiment, the processor determining whether the at least one relay comprises the plurality of relays comprises the processor determining whether the at least one relay comprises the plurality of relays based on radio thresholds preconfigured by a network.

In one embodiment, a method is performed by a layer three relay user equipment. In such an embodiment, the method comprises: receiving data from a first interface; transmitting the data from the first interface to a second interface; and maintaining a packet data convergence protocol sequence number in the data from the first interface when transmitting the data from the first interface to the second interface.

In certain embodiments, maintaining the packet data convergence protocol sequence number in the data from the first interface when transmitting the data from the first interface to the second interface comprises maintaining the packet data convergence protocol sequence number in the data from the first interface when transmitting the data from the first interface to the second interface in response to relaying with a plurality of relays.

In one embodiment, an apparatus comprises a layer three relay user equipment. In such an embodiment, the apparatus further comprises: a processor that: receives data from a first interface; transmits the data from the first interface to a second interface; and maintains a packet data convergence protocol sequence number in the data from the first interface when transmitting the data from the first interface to the second interface.

In certain embodiments, the processor maintaining the packet data convergence protocol sequence number in the data from the first interface when transmitting the data from the first interface to the second interface comprises the processor maintaining the packet data convergence protocol sequence number in the data from the first interface when transmitting the data from the first interface to the second interface in response to relaying with a plurality of relays.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a device, the method comprising:
selecting at least one relay for data information transmission, control information transmission, or a combination thereof;
determining whether the at least one relay comprises a plurality of relays; and
in response to determining that the at least one relay comprises a plurality of relays, transmitting information to a relay device indicating that the at least one relay comprises the plurality of relays.

2. The method of claim 1, wherein the device comprises a user equipment (UE) or a network device.

3. The method of claim 1, wherein determining whether the at least one relay comprises the plurality of relays comprises determining whether the at least one relay comprises the plurality of relays based on a logical channel configuration.

4. The method of claim 1, wherein determining whether the at least one relay comprises the plurality of relays comprises determining whether the at least one relay comprises the plurality of relays based on radio thresholds configured by a network.

5. The method of claim 1, wherein determining whether the at least one relay comprises the plurality of relays comprises determining whether the at least one relay comprises the plurality of relays based on radio thresholds preconfigured by a network.

6. A device, comprising:
at least one memory; and
at least one processor coupled with the at least one memory and configured to cause the device to:
select at least one relay for data information transmission, control information transmission, or a combination thereof;
determine whether the at least one relay comprises a plurality of relays; and
in response to determining that the at least one relay comprises a plurality of relays, transmit information to a relay device indicating that the at least one relay comprises the plurality of relays.

7. The device of claim 6, further comprising a user equipment (UE) or a network device.

8. The device of claim 6, wherein the at least one processor is configured to cause the device to determine whether the at least one relay comprises the plurality of relays based on a logical channel configuration.

9. The device of claim 6, wherein the at least one processor is configured to cause the device to determine whether the at least one relay comprises the plurality of relays based on radio thresholds configured by a network.

10. The device of claim 6, wherein the at least one processor is configured to cause the device to determine whether the at least one relay comprises the plurality of relays based on radio thresholds preconfigured by a network.

11. (canceled)

12. (canceled)

13. A user equipment (UE), comprising:
at least one memory; and
at least one processor coupled with the at least one memory and configured to cause the UE to:
receive data from a first interface;
transmit the data from the first interface to a second interface; and
maintain a packet data convergence protocol sequence number in the data from the first interface when transmitting the data from the first interface to the second interface.

14. The UE of claim 13, wherein the at least one processor is configured to cause the UE to maintain the packet data convergence protocol sequence number in the data from the first interface when transmitting the data from the first interface to the second interface in response to relaying with a plurality of relays.

15. A processor for wireless communication, comprising:
at least one controller coupled with at least one memory and configured to cause the processor to:
select at least one relay for data information transmission, control information transmission, or a combination thereof;
determine whether the at least one relay comprises a plurality of relays; and
in response to determining that the at least one relay comprises a plurality of relays, transmit information to a relay device indicating that the at least one relay comprises the plurality of relays.

16. The processor of claim 15, wherein the at least one controller is configured to cause the processor to determine whether the at least one relay comprises the plurality of relays based on a logical channel configuration.

17. The processor of claim 15, wherein the at least one controller is configured to cause the processor to determine whether the at least one relay comprises the plurality of relays based on radio thresholds configured by a network.

18. The processor of claim 15, wherein the at least one controller is configured to cause the processor to determine whether the at least one relay comprises the plurality of relays based on radio thresholds preconfigured by a network.
